(19) United States
(12) Patent Application Publication
(10) Pub. No.: US 2010/0061699 A1
(43) Pub. Date: Mar. 11, 2010

(54) METHOD AND APPARATUS FOR TRANSMITTING CONTENT AND METHOD AND APPARATUS FOR RECORDING CONTENT

(75) Inventors: Man-seok Kang, Suwon-si (KR); Sung-ryeul Rhyu, Yongin-si (KR); Dae-Jong Lee, Suwon-si (KR)

Correspondence Address: North Star Intellectual Property Law, PC, P.O. Box 34688, Washington DC, DC, 20043, US

(73) Assignee: Samsung Electronics Co., Ltd., Suwon-si (KR)

(21) Appl. No.: 12/551,695

(22) Filed: Sep. 1, 2009

(30) Foreign Application Priority Data
Sep. 10, 2008 (KR) 2008-89327

(51) Int. Cl. H04N 5/91; H04N 5/38; H04N 5/00

(52) U.S. Cl. 386/92; 348/723; 348/E05.093; 386/126

(57) ABSTRACT

A content transmitting method including: generating additional information regarding content including audio/video (A/V) data for multi-angle viewing, wherein the additional information is to be used to record the content; and transmitting the content and the additional information.

### CROSS-REFERENCE TO RELATED APPLICATION

This application claims the benefit of Korean Patent Application No. 2008-89327, filed on Sep. 10, 2008 in the Korean Intellectual Property Office, the disclosure of which is incorporated herein in its entirety by reference.

### BACKGROUND OF THE INVENTION

1. Field of the Invention

Aspects of the present invention relate to a method and apparatus to transmit content and a method and apparatus to record content.

2. Description of the Related Art

Today, advances in information and communication technology and data processing technology have led to an increase in a demand for a large amount of high-definition data. Next-generation recording media (such as digital versatile discs (DVDs) or Blu-ray discs), have been introduced to store a large amount of data, such as audio/video (A/V) data supporting multi-angle viewing. A/V data supporting multi-angle viewing includes a plurality of pieces of video that are captured at different angles at the same period of time, which allows a user to selectively view an image at a desired angle from among the plurality of pieces of video.

### SUMMARY OF THE INVENTION

Aspects of the present invention provide a method and apparatus to transmit content that includes audio/video (A/V) data supporting multi-angle viewing and a method and apparatus to record such content.

According to an aspect of the present invention, there is provided a content transmitting method including: generating additional information regarding content including A/V data for multi-angle viewing, wherein the additional information is used to record the content; and transmitting the content and the additional information.

The additional information may include content configuration information regarding the A/V data, wherein the content configuration information may include a name, a size, and/or a type of the A/V data, and/or multi-angle information indicating whether the A/V data is related to multi-angle viewing.

The A/V data may include first A/V data for a first angle and second A/V data for a second angle that are interleaved together.

The multi-angle information may include information of each of the interleaved first and second A/V data.

The content may further include navigation data used to control reproduction of the A/V data.

According to another aspect of the present invention, there is provided a content recording method including: receiving additional information regarding content including audio/video (A/V) data for multi-angle viewing, wherein the additional information is to used to record the content; and recording the content based on the additional information.

The additional information may include content configuration information regarding the A/V data, wherein the content configuration information may include a name, a size, and/or a type of the A/V data, and/or multi-angle information indicating whether the A/V data is related to multi-angle viewing.

The A/V data may include first A/V data for a first angle and second A/V data for a second angle interleaved together.

The A/V data may include first A/V data for a first angle and second A/V data for a second angle, and the recording of the content may include interleaving the first A/V data and the second A/V data together.

The content may include navigation data to control reproduction of the A/V data, and the recording of the content may include recording the A/V data on a Blu-ray disc based on the navigation data.

The interleaving of the first A/V data and the second A/V data may include: dividing the first A/V data and the second A/V data into predetermined sized interleaved blocks; and alternately recording the interleaved blocks of the first A/V data and the interleaved blocks of the second A/V data.

According to another aspect of the present invention, there is provided a content transmitting apparatus including: an information generation unit to generate additional information regarding content including A/V data for multi-angle viewing, wherein the additional information is used to record the content; and a transmitting unit to transmit the content and the additional information.

According to another aspect of the present invention, there is provided an apparatus to record content, the apparatus including: a receiving unit to receive additional information regarding content including audio/video (A/V) data for multi-angle viewing, wherein the additional information is used to record the content; and a recording unit to record the content based on the additional information.

According to yet another aspect of the present invention, there is provided a content recording method of a content recording apparatus, the method including: receiving additional information regarding content including audio/video (A/V) data for multi-angle viewing, wherein the additional information is used to record the content; determining, from the additional information, whether the content includes the A/V data for multi-angle viewing; when the content is determined to include the A/V data for multi-angle viewing, determining, from the additional information, whether the A/V data for multi-angle viewing is interleaved; recording, by the content recording apparatus, the content onto a storage medium based on the additional information when the A/V data for multi-angle viewing is determined to be interleaved; and interleaving first A/V data for a first angle of the multi-angle viewing with second A/V data for a second angle of the multi-angle viewing and recording, onto the storage medium, the first A/V data and the second A/V data in an interleaved state when the A/V data for multi-angle viewing is determined to not be interleaved.

According to still another aspect of the present invention, there is provided a system to record content, the system including: a content transmitting apparatus including: an information generation unit to generate additional information regarding the content including audio/video (A/V) data for multi-angle viewing, wherein the additional information is used to record the content, and a transmitting unit to transmit the content and the additional information; and a content recording apparatus including: a receiving unit to receive the content and the additional information regarding the content; and a recording unit to record the content onto a storage medium based on the additional information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a content transmitting apparatus according to an embodiment of the present invention;

FIG. 2 illustrates a construction of content transmitted via a content transmitting apparatus according to an embodiment of the present invention;

FIG. 3 illustrates content configuration information transmitted via a content transmitting apparatus according to an embodiment of the present invention;

FIG. 4 illustrates content configuration information transmitted via a content transmitting apparatus according to another embodiment of the present invention;

FIG. 5 is a block diagram of a content recording apparatus according to an embodiment of the present invention;

FIG. 6 is a diagram illustrating recording of content by a content recording apparatus according to an embodiment of the present invention;

FIG. 7 is a diagram illustrating recording of content by a content recording apparatus according to another embodiment of the present invention;

FIG. 8 is a diagram illustrating a process of reproducing content by a content reproducing apparatus according to an embodiment of the present invention;

FIG. 9 is a flowchart illustrating a content transmitting method according to an embodiment of the present invention;

FIG. 10 is a flowchart illustrating a content recording method according to an embodiment of the present invention; and

FIG. 11 is a flowchart illustrating a content recording method according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

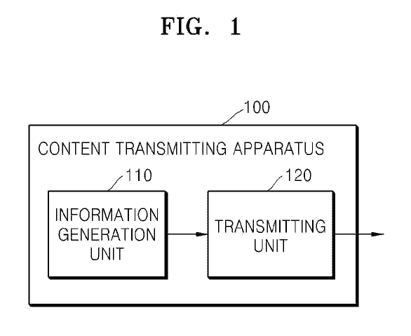

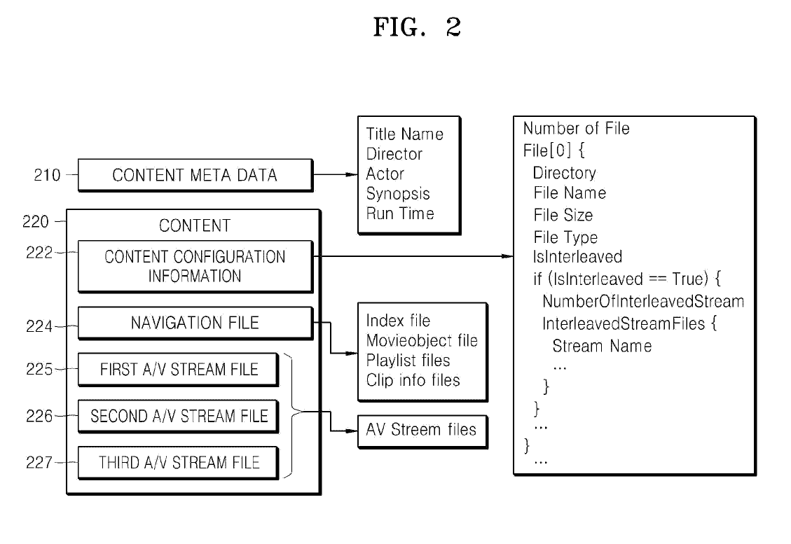

FIG. 1 is a block diagram of a content transmitting apparatus 100 according to an embodiment of the present invention. The content transmitting apparatus 100 may be a personal computer, a notebook computer, a mobile device, a workstation, etc. Referring to FIG. 1, the content transmitting apparatus 100 includes an information generation unit 110 and a transmitting unit 120. The information generation unit 110 generates additional information used to record content. The additional information may be any information used to record the content to enable multi-angle viewing. In the present specification, the term, “multi-angle” denotes an operation allowing a user to select and view one of at least two pieces of video that are captured at different angles, for a same period of time. In order to support multi-angle, two or more pieces of audio/video (A/V) data that are captured at different angles are used. The additional information may include content configuration information regarding at least one piece of data constituting the content. An example of the content configuration information will be described later with reference to FIG. 2.

The content configuration information may include a name, a size, and/or a type of the at least one piece of data, and/or multi-angle information indicating whether each of the at least one piece of data supports multi-angle viewing. The multi-angle information may include various information related to multi-angle viewing, such as a total number of angles and/or a name and/or size of A/V data for each of the angles.

The content transmitted via the content transmitting apparatus 100 may include various types of data (such as A/V data that supports multi-angle viewing, A/V data that does not support multi-angle viewing, and navigation data used to control such A/V data). Hereinafter, for convenience of explanation, it is assumed that the content includes A/V data that supports multi-angle viewing. Aspects of the present invention will now be described with respect to A/V data supporting multi-angle viewing.

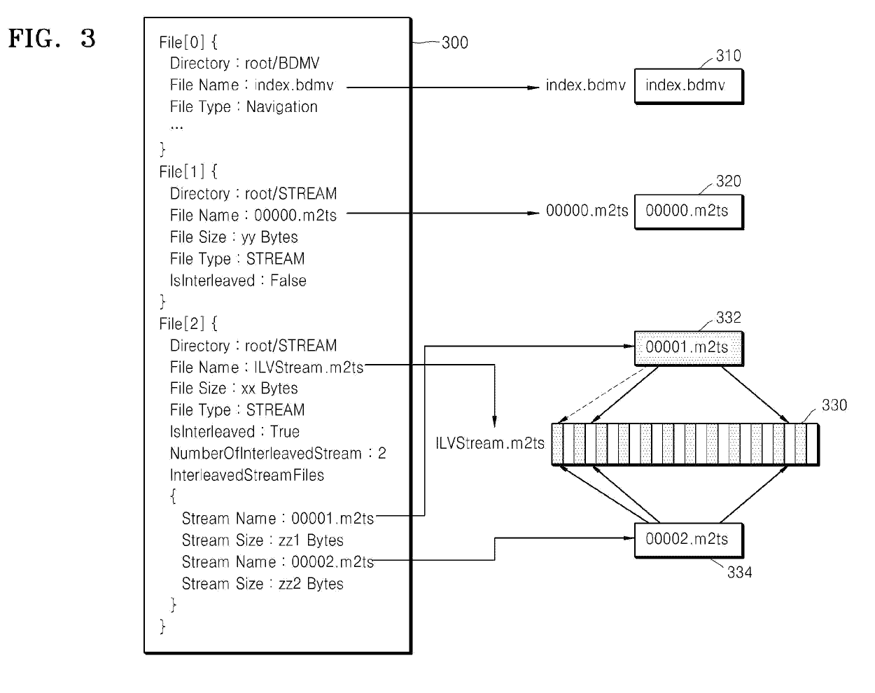

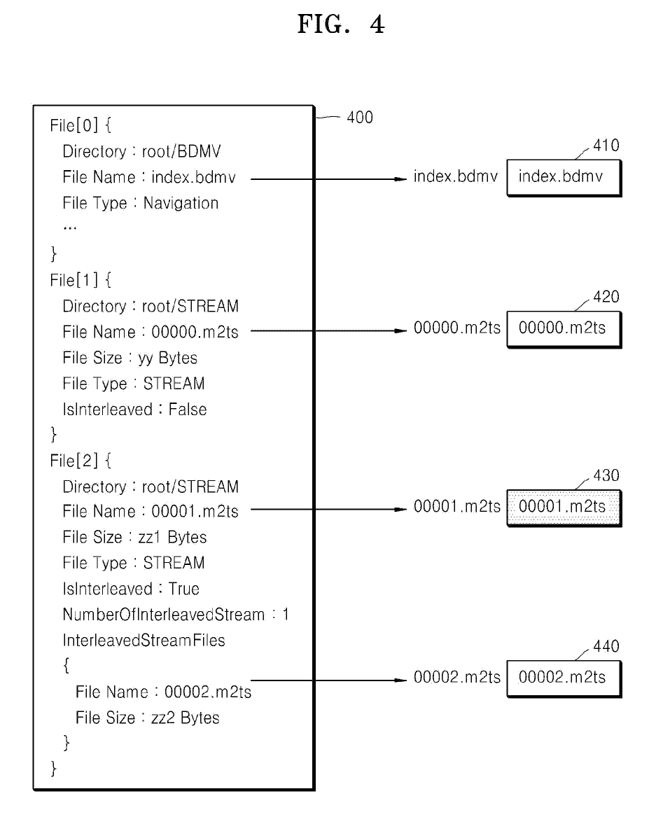

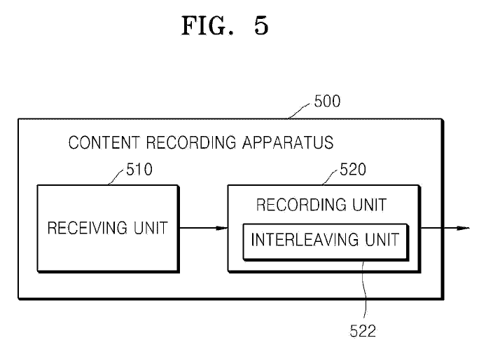

A plurality of pieces of A/V data supporting multi-angle viewing may be interleaved and transmitted in one stream or may be independently transmitted without being interleaved. It is assumed that there are provided first A/V data and second A/V data that are obtained by respectively photographing a same subject, for a same period of time, at a first angle and a second angle different from the first angle. In this case, the first A/V data and the second A/V data may be transmitted in the form of separate streams or may be interleaved and transmitted in one stream. If the first and second A/V data are interleaved and transmitted in one stream, a content recording apparatus 500 (which will be described later with reference to FIG. 5) may directly record the stream on a recording medium. However, if the first and second A/V data are transmitted in separate streams, the content recording apparatus 500 records the first and second A/V data on a recording medium in an interleaving manner. An example of a case where the first and second A/V data are interleaved and transmitted in one stream will be described later with reference to FIG. 3, and an example of a case where the first and second A/V data are transmitted in separate streams will be described later with reference to FIG. 4.

The information generation unit 110 may further generate meta data regarding the content. The meta data regarding the content may be any data related to the content, such as a title name, director, run time, actors, and synopsis of the content.

The transmitting unit 120 transmits the content and the additional information. The transmitting unit 120 may transmit the content together with the additional information via a network (such as the Internet or an IEEE 1394 network), or directly via a wired and/or wireless protocol (such as USB, infrared, Bluetooth, etc.). Alternatively, the transmitting unit 120 may transmit the additional information separately from the content. Also, the transmitting unit 120 may further transmit the meta data regarding the content. Accordingly, a user may select content to be received or sort out content received based on the meta data regarding the content.

FIG. 2 illustrates a construction of content 220 transmitted via the content transmitting apparatus 100 of FIG. 1 according to an embodiment of the present invention. Referring to FIG. 2, the content 220 includes content configuration information 222, a navigation file 224, and A/V stream files 225 through 227.

The navigation file 224 is information to control reproduction of the A/V stream files 225 through 227. For example, when the content 220 is recorded on a Blu-ray disc, the navigation file 224 may include an index file, a movie object file, a playlist file, and/or clip information files. It is understood that aspects of the present invention are not limited thereto, and information included in the navigation file 224 may vary according to a type of a recording medium on which the navigation file 224 is to be recorded.

In the illustrated embodiment, the first A/V stream file 225 is an A/V stream file that is not related to multi-angle viewing. Conversely, the second A/V stream file 226 and the third A/V stream file 227 are A/V stream files related to multi-angle viewing. While not restricted thereto, in the illustrated embodiment, it is assumed that the second and third A/V stream files 226 and 227 are interleaved and transmitted in one A/V stream file and the A/V stream file corresponds to a “file[0]” field included in the content configuration information 222, which will be described in detail later.

As described above, the content configuration information 222 is an example of additional information used to record the content 220 and provides information regarding the files 224 through 227 constituting the content 220. The content configuration information 222 includes a “Directory” field, a “File Name” field, a “File Size” field, a “File Type” field, an “IsInterleaved” field, a “NumberOfInterleavedStream” field, and an “InterleavedStreamFiles” field, though aspects of the present invention are not limited thereto. That is, according to other aspects, the content configuration information 222 can include other fields and/or can exclude one or more of the fields described above.

The “Directory” field indicates a directory used to record the files 224 through 227 on a recording medium. The “file Name” field and the “file Size” field respectively indicate the name and the size of each of the files 224 through 227. The “file Type” field indicates the types of the files 224 through 227, whereby each of the files 224 through 227 may be classified into navigation files and A/V stream files and/or A/V stream files may be subdivided into A/V stream files related to multi-angle viewing and A/V stream files not related to multi-angle viewing. As described above, file types may be categorized into various types according to an embodiment of the present invention.

The “Islnterleaved” field indicates whether a current file corresponding to the “file[0]” field has been interleaved or is to be interleaved. That is, the “Islnterleaved” field indicates whether the file corresponding to the “file[0]” field is an A/V stream file related to multi-angle viewing. Referring to FIG. 2, the value of the “IsInterleaved” field indicates “True.” If the file corresponding to the “file[0]” field is an A/V stream file related to multi-angle viewing, a “NumberOfInterleavedStream” field indicates a total number of A/V stream files that are interleaved in the current file corresponding to the “file[0]” field. That is, the “NumberOfInterleavedStream” field contains information indicating a total number of angles that are supported by the content 220. Referring to FIG. 2, the “NumberOfInterleavedStream” field has a value of 2. The “InterleavedStream files” field indicates information regarding interleaved A/V stream files (e.g., names and sizes thereof). That is, the “InterleavedStream files” field includes information regarding A/V stream files for multi-angle viewing. Referring to FIG. 2, the “InterleavedStream files” field includes information regarding the second and third A/V stream files 226 and 227, which relate to multi-angle viewing.

Content meta data 210 may include any information related to the content 220, such as the title name, director, run time, actors, and synopsis of the content 220.

FIG. 3 illustrates content configuration information 300 transmitted via the content transmitting apparatus 100 of FIG. 1 according to an embodiment of the present invention. Referring to FIG. 3, two A/V data files that are related to multi-angle viewing and are logically differentiated from each other, are interleaved and transmitted in one A/V stream file. The content configuration information 300 is an example of additional information used to record content.

Referring to the “File Name” field and the “File Type” field, an “index.bdmv” file 310 corresponding to a “file [0]” field is a navigation file, and a “00000.m2ts” file 320 corresponding to a “file [1]” field and an “ILVStream.m2ts” file 330 corresponding to a “file [2]” field are A/V stream files.

Referring to the “IsInterleaved” field, the “00000.m2ts” file 320 is an A/V stream file that is not related to multi-angle viewing and the “ILVStream.m2ts” file 330 is an A/V stream file that is related to multi-angle viewing.

Referring to the “NumberOfInterleavedStream” field and the “InterleavedStream files” field, a “00001.m2ts” file 332 and a “00002.m2ts” 334 file are interleaved in the “ILVStream.m2ts” file 330 corresponding to the “file [2]” field.

Files included in content transmitted via the content transmitting apparatus 100 of FIG. 1 according to an embodiment of the present invention are illustrated in a right part of FIG. 3. The content includes the “index.bdmv” file 310, the “00000.m2ts” file 320, and the “ILVStream.m2ts” 330 file. The “ILVStream.m2ts” file 330 is a stream file in which the “00001.m2ts” file 332 and the “00002.m2ts” file 334 are interleaved. In the “ILVStream.m2ts” file 330, shaded portions correspond to the “00001.m2ts” file 332 and non-shaded portions correspond to the “00002.m2ts” file 334.

FIG. 4 illustrates content configuration information 400 transmitted via the content transmitting apparatus 100 of FIG. 1 according to another embodiment of the present invention. Referring to FIG. 4, two A/V data files that are related to multi-angle viewing and are logically differentiated from each other, are not interleaved. Rather, the two A/V data files are transmitted in separate A/V stream files. The content configuration information 400 is an example of additional information used to record content. The content configuration information 400 of FIG. 4 is the same as the content configuration information 300 of FIG. 3 except for a “file [2]” field. Therefore, a description of a “file [0]” field and a “file [1]” field will not be provided herein.

The “file [2]” field contains information regarding a “0001.m2ts” file 430. Referring to the “NumberOfInterleavedStream” field and the “InterleavedStream files” field, both the “0001.m2ts” file 430 and a “0002.m2ts” file 440 are indicated as A/V data for multi-angle viewing.

The types and formats of fields included in the content configuration information 400 may vary in other embodiments of the present invention. For example, a field indicating that a plurality of A/V streams related to multi-angle viewing are transmitted without being interleaved may be included in the content configuration information 400 according to another embodiment. Also, all information regarding the “0001.m2ts” file 430 and the “0002.m2ts” file 440 may be included in the “file [2]” field or may be included separately from the “file [2]” field.

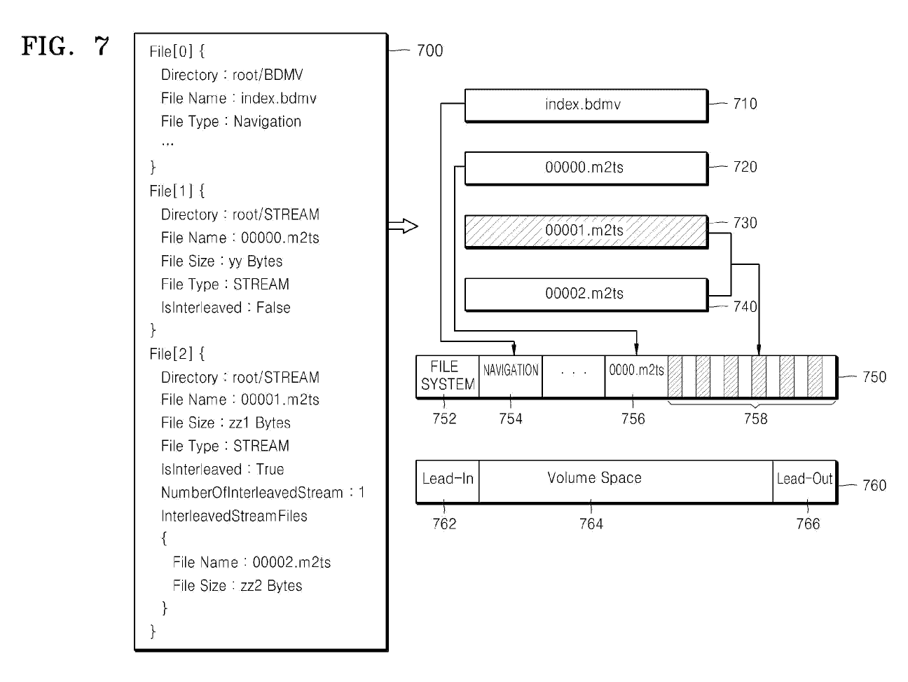

Files included in content transmitted via the content transmitting apparatus 100 according to an embodiment of the present invention are illustrated in a right part of FIG. 4. As illustrated, the content includes an “index.bdmv” file 410, a “00000.m2ts” file 420, a “00001.m2ts” file 430, and a “00002.m2ts” file 420. The “00001.m2ts” file 420 and the “00002.m2ts” file 430, which are A/V stream files related to multi-angle viewing in the shown example, are not interleaved and are respectively transmitted via two stream files. A content recording apparatus 500, which will be described later, interleaves and records the “00001.m2ts” file 420 and the “00002.m2ts” file 430 based on the content configuration information 400 according to an embodiment of the present invention. A method of recording the “00001.m2ts” file 420 and the “00002.m2ts” file 430 while interleaving the files 420 and 430 will be described later with reference to FIG. 7.

FIG. 5 is a block diagram of a content recording apparatus 500 according to an embodiment of the present invention. The content recording apparatus 500 may be a personal computer, a notebook computer, a workstation, a server, etc. Referring to FIG. 5, the content recording apparatus 500 includes a receiving unit 510 and a recording unit 520.

The receiving unit 510 receives content and additional information that is related to the content and is used to record the content, via a network (such as the Internet or an IEEE 1394 network), or directly via a wired and/or wireless protocol (such as USB, infrared, Bluetooth, etc.). The content may include at least one of A/V data that is related to multi-angle viewing, A/V data that is not related to multi-angle viewing, and navigation data.

The additional information may include various type of information used to record the content. For example, the additional information may include content configuration information regarding at least one piece of data constituting the content. If the content includes A/V data for multi-angle viewing, the content configuration information may include the name, size, and/or type of the A/V data, and/or multi-angle information indicating that the A/V data is related to multi-angle viewing. Hereinafter, the shown embodiment will be described with respect to A/V data related to multi-angle viewing.

The recording unit 520 records the content based on the additional information. The content may be recorded on various types of recording media, such as a digital versatile disc (DVD), a compact disc-rewritable (CD-RW), a hard disc drive, or a Blu-ray disc. For convenience of the present description, a Blu-ray disc is provided as a non-limiting example of a recording medium on which the content is to be recorded.

A plurality of pieces of A/V data related to multi-angle viewing may be interleaved and included in the received content, but it is understood that aspects of the present invention are not limited thereto and the plurality of pieces of A/V data may be included without being interleaved. However, when the content is to be recorded on a Blu-ray disc, the plurality of pieces of A/V data related to multi-angle viewing are recorded after being interleaved.

If the plurality of pieces of A/V data related to multi-angle viewing are interleaved and included in the received content, the recording unit 520 creates file system data regarding allocation and management of the A/V data based on the additional information, and records the file system data and the interleaved A/V data on a Blu-ray disc. In contrast, if the plurality of pieces of A/V data related to multi-angle viewing are included in the received content without being interleaved, the recording unit 520 interleaves the A/V data while, before, or after creating the file system data and records the interleaved A/V data and the file system data on the Blu-ray disc.

For convenience of the present description, as a non-limiting example, it is assumed that A/V data related to multi-angle viewing includes first A/V data for a first angle and second A/V data for a second angle. The recording unit 520 includes an interleaving unit 522 to interleave the first A/V data and the second A/V data when the first A/V data and the second A/V data are included in the received content without being interleaved. Specifically, the interleaving unit 522 divides the first A/V data and the second A/V data into predetermined-sized interleaved blocks. In this case, the sizes of the interleaved blocks are determined from clip information corresponding to the first A/V data and the second A/V data, though aspects of the present invention are not limited thereto. The sizes of the interleaved blocks may be the same or may be different from each other. If the first A/V data and the second A/V data are divided into the predetermined-sized interleaved blocks, the recording unit 520 alternately records the interleaved blocks of the first A/V data and the interleaved blocks of the second A/V data onto the Blu-ray disc.

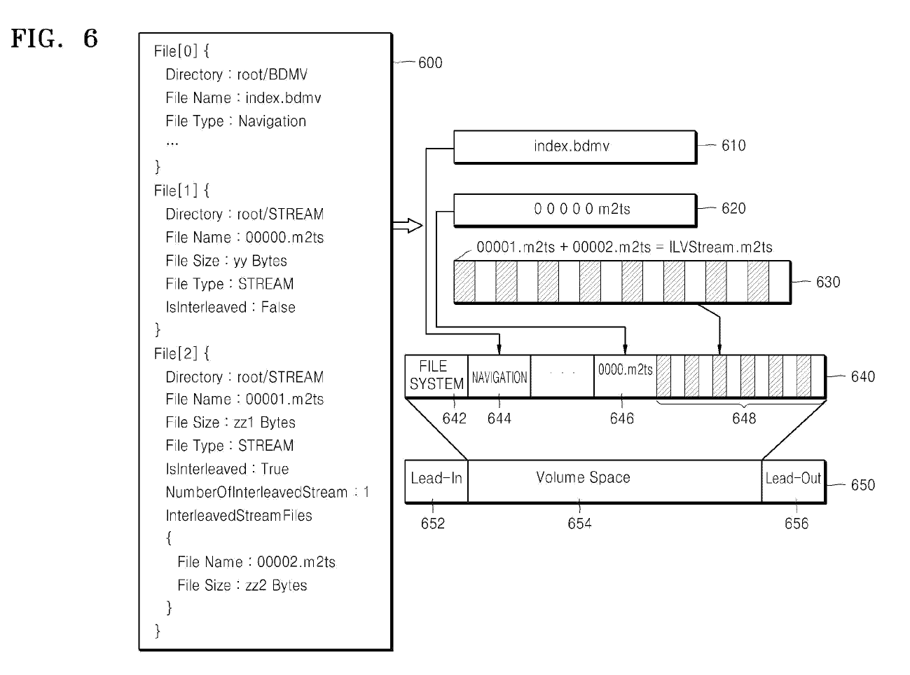

A case where a plurality of pieces of A/V data related to multi-angle viewing are interleaved and included in received content will be described later with reference to FIG. 6, and a case where such a plurality of pieces of A/V data are included in received content without being interleaved will be described later with reference to FIG. 7.

FIG. 6 is a diagram illustrating recording of content by the content recording apparatus 500 of FIG. 5 according to an embodiment of the present invention. Referring to FIG. 6, the content includes a plurality of pieces of A/V data for multi-angle viewing that are interleaved.

Content configuration information 600 is an example of additional information used to record the content. Referring to the content configuration information 600, the content includes three files. The content configuration information 600 is similar to the content configuration information 300 illustrated in FIG. 3 and, thus, a description thereof will not be provided herein.

Files included in the content and the relationship among the files and a disc on which the files are to be recorded, are illustrated in a right part of FIG. 6. An example of the disc on which the files are to be recorded includes a Blu-ray disc 650, though aspects of the present invention are not limited to the Blu-ray disc 650. That is, aspects of the present invention are also applicable to other types of storage media, such as a DVD, a CD, a hard disk drive, etc.

The Blu-ray disc 650 includes a lead-in region 652, a volume space 654 storing data 640, and a lead-out region 656. The data 640 stored in the volume space 654 includes a file system 642, a navigation file 644, and stream files 646 and 648. The file system 642 includes file system data regarding a physical arrangement and management of the data 640 on the Blu-ray disc 650. The navigation file 644 includes navigation data, which is information to control a reproduction of the data 640. The navigation data may include information regarding streams (e.g., the total number and locations of logically identified streams recorded on the Blu-ray disc 650). The navigation data may also include clip information that is additional information regarding each of the logically identified streams. The stream files 646 and 648 include data streams recorded on the Blu-ray disc 650. Referring to FIG. 6, the stream files 646 and 648 include A/V data files, though aspects of the present invention are not limited to the A/V data files, and files of another format, such as a data text file, may be recorded.

The content includes three files, i.e., an “index.bdmv” file 610, a “00000.m2ts” file 620 and an “ILVStream.m2ts” file 630. The “index.bdmv” file 610 is a navigation file and is recorded in the navigation file field 644 in the data 640. The “00000.m2ts” file 620 is an A/V data file that is not related to multi-angle viewing and is stored in the stream field 646 in the data 640. The “ILVStream.m2ts” file 630 is an A/V data file that is related to multi-angle viewing and is stored in the stream field 648 in the data 640. In the “ILVStream.m2ts” file 630, a “00001.m2ts” file and a “00002.m2ts” file are interleaved. Specifically, in the “ILVStream.m2ts” file 630, shaded blocks are related to the “00001.m2ts” file, and other non-shaded blocks are related to the “00002.m2ts” file.

A process of recording the content on the Blu-ray disc 650 by using the content recording apparatus 500, based on the content configuration information 600, according to an embodiment of the present invention, will now be described. First, the content recording apparatus 500 receives the content configuration information 600 and the content from the content transmitting apparatus 100. The content transmitting apparatus 100 and the content recording apparatus 500 may be connected via an external communication network such as the Internet, and IEEE 1394 network, and/or any wired/wireless protocol (such as USB, infrared, Bluetooth, etc.).

After receiving the content configuration information 600, the content recording apparatus 500 creates a list of files that are to be recorded on the Blue-ray disc 650 by parsing the content configuration information 600 and determines whether the list of the files include A/V data supporting multi-angle viewing. Referring to FIG. 5, the “ILVStream.m2ts” file is A/V data related to multi-angle viewing.

The content recording apparatus 500 determines from the content configuration information 600 that the “00001.m2ts” file and the “00002.m2ts” file are interleaved in the “ILVStream.m2ts” file 630 and then obtains information regarding interleaving. The information regarding interleaving may include size information of interleaved blocks, and/or the size information of the interleaved blocks may be checked by analyzing clip information of the “00001.m2ts” file and clip information of the “00002.m2ts” file. For example, the clip information may include location information regarding an entry point where angle switching may be performed. The size information of the interleaved blocks may be obtained from the location information regarding the entry point, since file division may be performed based on the location of the entry point or for every predetermined number of entry points.

The above-mentioned clip information may be transmitted in navigation data. In this case, the content recording apparatus 500 obtains the clip information of the “00001.m2ts” file and the “00002.m2ts” file from the “index.bdmv” file 610 in order to check the sizes of the interleaved blocks.

When obtaining the size information of the interleaved blocks, the content recording apparatus 500 creates file system data based on the information regarding interleaving and the list of files to be recorded. After the file system data is created, the file system data is recorded in the file system field 642, the “index.bdmv” file 610 is recorded in the navigation field 644 based on the file system data, and the “00000.m2ts” file 620 and the “ILVStream.m2ts” file 630 are recorded in the stream fields 646 and 648.

A plurality of pieces of A/V data related to multi-angle viewing are interleaved and recorded on the Blu-ray disc 650. Thus, when A/V data is received via the Internet and is recorded on the Blue-ray disc 650, it is impossible to record the A/V data in order to support multi-angle viewing if the information regarding interleaving cannot be identified. However, a content recording apparatus according to an embodiment of the present invention is capable of receiving additional information to record content together with the content, and of recording A/V data in order to support multi-angle viewing by using the additional information.

FIG. 7 is a diagram illustrating recording of content by the content recording apparatus 500 of FIG. 5 according to another embodiment of the present invention. Referring to FIG. 7, a plurality of pieces of A/V data for multi-angle are included in the content without being interleaved.

Content configuration information 700 is an example of additional information used to record the content. The content configuration information 700 illustrated in FIG. 7 is similar to the content configuration information 400 illustrated in FIG. 4 and, thus, a description thereof will not be provided herein.

Files included in the content and the relationship among the files and a disc to which the files are to be recorded are illustrated in a right part of FIG. 7. The content includes four files, i.e., an “index.bdmv” file 710, a “00000.m2ts” file 720, a “00001.m2ts” file 730, and a “00002.m2ts” file 740. The “index.bdmv” 710 file is navigation data and is recorded in a navigation file field 754 in a data construction 750. The “00000.m2ts” 720 file is an A/V data file that is not related to multi-angle viewing and is recorded in a stream field 756 in the data construction 750. The “00001.m2ts” file 730 and the “00002.m2ts” 740 file are A/V data related to multi-angle viewing and are interleaved and stored in a stream field 758.

Hereinafter, a process of recording content on a Blue-ray disc by the content recording apparatus 500, based on the content configuration information 700, according to an embodiment of the present invention will be described. After receiving the content configuration information 700, the content recording apparatus 500 creates a list of files that are to be recorded on a Blu-ray disc 760 by parsing the content configuration information 700, and determines whether the list of files include A/V data related to multi-angle viewing. Referring to FIG. 7, a “00001.m2ts” file 730 and a “00002.m2ts” 740 file are A/V data related to multi-angle viewing.

The content recording apparatus 500 obtains clip information of a “00001.m2ts” file and a “00002.m2ts” file from the “index.bdmv” 710 file in order to obtain information regarding interleaving, such as size information of interleaved blocks. However, it is understood that aspects of the present invention are not limited to the clip information, and the information regarding interleaving may be included separately from the clip information.

The content recording apparatus 500 creates file system data based on the information regarding interleaving and the list of files. After creating the file system data, the file system data is recorded in the file system field 742, the “index.bdmv” file 710 is recorded in the navigation file field 754 based on the file system data, the “00000.m2ts” file 720 is recorded in the stream field 756, and the “00001.m2ts” file 730 and the “00002.m2ts” 740 file are recorded in the stream field 748.

In this case, data is extracted from the “00001.m2ts” file 730 and the “00002.m2ts” file 740 in predetermined units, based on the size information of the interleaved blocks, and is alternatively recorded. That is, data is extracted from the “00001.m2ts” file 730 in one interleaved block unit and is recorded, and then data is extracted from the “00002.m2ts” file 740 in another interleaved block unit and is recorded. Next, data is obtained from the “00001.m2ts” file 730 in another interleaving block unit and is recorded. In this way, the “00001.m2ts” file 730 and the “00002.m2ts” 740 file are interleaved and recorded in the stream field 758.

As described above, even if a plurality of pieces of A/V data for multi-angle viewing are received without being interleaved, a content recording apparatus according to another embodiment of the present invention interleaves the plurality of pieces of A/V data based on additional information regarding the content, and then records the plurality of pieces of A/V data on the Blu-ray disc, thereby providing a user with a multi-angle viewing operation.

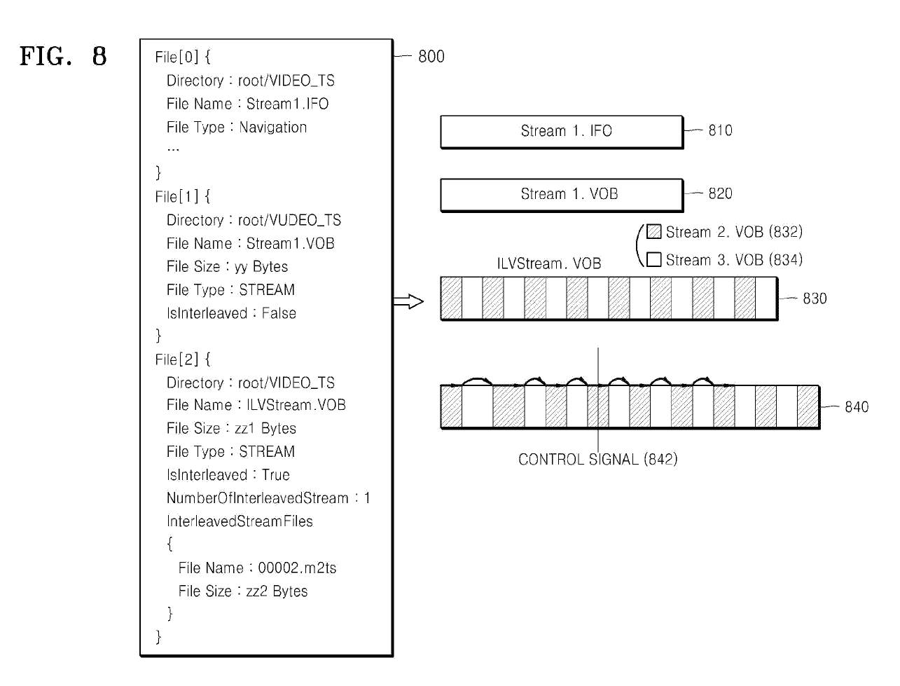

FIG. 8 is a diagram illustrating a process of reproducing content performed by a content reproducing apparatus according to an embodiment of the present invention. Referring to FIG. 8, content configuration information 800 is an example of additional information used to record the content. Files included in the content and the process of reproducing the content are illustrated in a right part of FIG. 8.

The content includes a “Stream 0.IFO” file 810, a “Stream 1.VOB” file 820 and an “ILVStream.VOB” file 830. The “Stream 0.IFO” file 810 is navigation data and is used to control reproduction of an A/V stream. The “Stream 1.VOB” file 820 is A/V data that is not related to multi-angle viewing. The “ILVStream.VOB” file 830 is A/V data that supports multi-angle viewing. In the “ILVStream.VOB” file 830, a “Stream 2.VOB” file 832 for a first angle and a “Stream 3.VOB” file 834 for a second angle are interleaved and included therein.

A process of reproducing content by a content reproducing apparatus based on content configuration information 800 according to an embodiment of the present invention will now be described. First, the content reproducing apparatus receives the content and the content configuration information 800 from the content transmitting apparatus 100 (for example, when a user requests reproduction of the content or simply requests the content).

After the content and the content configuration information 800 are received, a list of files that are to be reproduced are generated based on the content configuration information 800. Then, the content reproducing apparatus first processes navigation data and reproduces a stream file indicated by the navigation data. As an example, it is assumed that the navigation data indicates a “Stream 2.VOB” 832. If a file indicated by the navigation data is related to multi-angle viewing, the content reproducing apparatus obtains multi-angle information from the content configuration information 800. Accordingly, the content reproducing apparatus determines that the “Stream 2.VOB” 832 is A/V data for the first angle from among the multi-angle and is interleaved with the “ILVStream.VOB” file 830.

The content reproducing apparatus reproduces the “Stream 2.VOB” 832 by accessing the “ILVStream.VOB” file 830 interleaved with the “Stream 2.VOB” 832. In this case, the content reproducing apparatus obtains, from the navigation data, clip information of the “Stream 2.VOB” 832 from the navigation data and checks the sizes of interleaved blocks based on the clip information. Then, the content reproducing apparatus repeatedly reproduces or skips reproduction of the “ILVStream.VOB” file 830 based on the sizes of the interleaved blocks. In detail, the “Stream 2.VOB” 832 is reproduced by repeatedly reproducing or skipping reproduction of each of the interleaved blocks of the “ILVStream.VOB” file 830.

Now, a case where a control signal 842 requesting angle switching is input from a user during reproduction of the “Stream 2.VOB” 832 will be described. The content reproducing apparatus obtains, from the navigation data, clip information of an A/V data file for an angle to be switched. Referring to FIG. 8, clip information of the “Stream 3.VOB” 834 is obtained. The content reproducing apparatus determines the sizes of interleaved blocks based on the clip information of the “Stream 3.VOB” 834, and reproduces the “Stream 3.VOB” 834 by repeatedly reproducing and skipping reproduction of each of the interleaved blocks. However, if angle switching is not possible at a point of time when the control signal 842 is received, the “Stream 2.VOB” 832 is reproduced up to a point of time when angle switching is possible, and then the “Stream 3.VOB” 834 is reproduced.

Although not illustrated in FIG. 8, if the “Stream 2.VOB” file 832 and the “Stream 3.VOB” file 834 that is related to multi-angle viewing are included in the content without being interleaved, the “Stream 2.VOB” file 832 or the “Stream 3.VOB” file 834 is reproduced in the same way as a general A/V stream is reproduced. However, if a user request regarding angle switching is received during reproduction of the “Stream 2.VOB” file 832 or the “Stream 3.VOB” file 834, clip information of the file that is being reproduced and clip information of a file related to an angle that is to be switched to are obtained in order to determine which part of A/V data regarding the angle is to be switched to.

As described above, a content reproducing apparatus according to an embodiment of the present invention reproduces A/V data related to multi-angle viewing by using additional information, even if content has yet to be recorded.

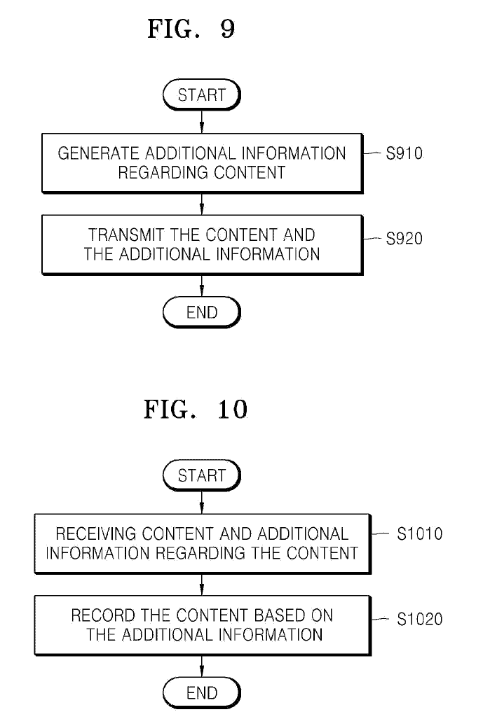

FIG. 9 is a flowchart illustrating a method of transmitting content according to an embodiment of the present invention. Referring to FIG. 9, additional information regarding the content is generated in operation S910. The content includes A/V data that is related to multi-angle viewing, A/V data that is not related to multi-angle viewing, and navigation data to control reproduction of the A/V data. The additional information is any information used to record the content on a recording medium. For example, the additional information may include content configuration information regarding at least one piece of data constituting the content. Furthermore, the content configuration information may include a name, a size, and/or a type of the at least one piece of data constituting the content, and/or multi-angle information. The multi-angle information indicates whether the at least one piece of data constituting the content supports multi-angle viewing.

Thus if the content includes A/V data related to multi-angle viewing, the additional information may include the name, the size, and/or the type of the A/V data, and/or multi-angle information indicating whether the A/V data is related to multi-angle viewing. The A/V data related to multi-angle viewing may be either a combination of first A/V data related to a first angle and second A/V data related to a second angle that are interleaved, or the first A/V data and the second A/V data that are not interleaved. As described above, information regarding a plurality of pieces of A/V data for multi-angle viewing may be included in the multi-angle information. The content and the generated additional information are transmitted in operation S920.

FIG. 10 is a flowchart illustrating a method of recording content according to an embodiment of the present invention. Referring to FIG. 10, the content and additional information regarding the content are received in operation S1010. The additional information may include content configuration information regarding at least one piece of data constituting the content.

Then, the received content is recorded based on the received additional information in operation S1020. The content may be recorded on various recording media, such as a Blu-ray disc, a DVD, a hard disc drive, etc. Furthermore, a plurality of pieces of A/V data related to multi-angle viewing may be interleaved and included in the content or may be included without being interleaved. In order to record a plurality of pieces of A/V data related to multi-angle viewing on the recording medium, the plurality of pieces of A/V data are interleaved and recorded. That is, if the plurality of pieces of A/V data related to multi-angle viewing are not interleaved and included in the content, the plurality of pieces of A/V data are interleaved and recorded in operation S1020.

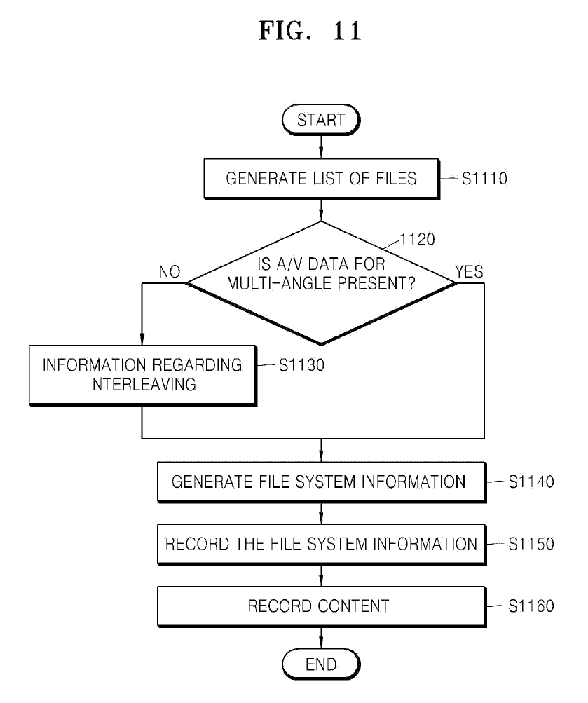

FIG. 11 is a flowchart illustrating a method of recording content according to another embodiment of the present invention. Referring to FIG. 11, a list of files that are to be recorded based on additional information regarding the content is generated in operation S1110.

Based on the generated list of files (Operation S1110), it is determined whether the files that are to be recorded include an A/V data file for multi-angle viewing in operation S1120. In order to record an A/V data file for multi-angle viewing, information regarding interleaving is checked in operation S1130. The content may include navigation data files to control reproduction of the A/V data file and the information regarding interleaving may be included in the navigation data.

File system data related to arrangement of and recording management of the data is created in operation S1140, and recorded in operation S1150. The content is recorded based on the file system data in operation S1160. On a Blu-ray disc, A/V data files for multi-angle are interleaved and recorded. If the A/V data files for multi-angle viewing are included in the content without being interleaved, the A/V data files for multi-angle viewing are interleaved and recorded.

While not restricted thereto, aspects of the present invention can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet. Moreover, while not required in all aspects, one or more units of the content transmitting apparatus 100 and/or the content recording apparatus 500 can include a processor or microprocessor executing a computer program stored in a computer-readable medium, such as a local storage.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A content transmitting method of a content transmitting apparatus, the method comprising:
generating, by the content transmitting apparatus, additional information regarding content including audio/video (A/V) data for multi-angle viewing, wherein the additional information is used to record the content; and
transmitting, by the content transmitting apparatus, the content and the additional information to a content recording apparatus that records the content onto a storage medium according to the additional information.

2. The method as claimed in claim 1, wherein:
the additional information comprises content configuration information regarding the A/V data; and
the content configuration information comprises a name, a size, and/or a type of the A/V data, and/or multi-angle information indicating whether the A/V data is related to the multi-angle viewing.

3. The method as claimed in claim 2, wherein:
the A/V data comprises first A/V data for a first angle of the multi-angle viewing, and second A/V data for a second angle of the multi-angle viewing; and
the transmitting of the content and the additional information comprises transmitting the first A/V data and the second A/V data as interleaved together.

4. The method as claimed in claim 3, wherein the multi-angle information comprises information on each of the interleaved first and second A/V data.

5. The method as claimed in claim 1, wherein the content further comprises navigation data used to control reproduction of the A/V data.

6. A content recording method of a content recording apparatus, the method comprising:
receiving additional information regarding content including audio/video (A/V) data for multi-angle viewing, wherein the additional information is used to record the content; and
recording, by the content recording apparatus, the content onto a storage medium based on the additional information.

7. The method as claimed in claim 6, wherein:
the additional information comprises content configuration information regarding the A/V data; and
the content configuration information comprises a name, a size, and/or a type of the A/V data, and/or multi-angle information indicating whether the A/V data is related to the multi-angle viewing.

8. The method as claimed in claim 6, further comprising:
receiving the A/V data comprising first A/V data for a first angle of the multi-angle viewing and second A/V data for a second angle of the multi-angle viewing interleaved together.

9. The method as claimed in claim 7, wherein:
the A/V data comprises first A/V data for a first angle of the multi-angle viewing and second A/V data for a second angle of the multi-angle viewing; and
the recording of the content comprises interleaving, according to the additional information, the first A/V data and the second A/V data together and recording the first A/V data and the second A/V data in an interleaved state.

10. The method as claimed in claim 8, wherein:
the content comprises navigation data to control reproduction of the A/V data; and
the storage medium is a Blu-ray disc.

11. The method as claimed in claim 8, wherein the interleaving of the first A/V data and the second A/V data comprises:
dividing the first A/V data and the second A/V data into predetermined sized interleaved blocks; and
alternately recording the interleaved blocks of the first A/V data and the interleaved blocks of the second A/V data onto the storage medium.

12. The method as claimed in claim 6, further comprising:
determining, from the additional information, whether the content includes the A/V data for multi-angle viewing.

13. The method as claimed in claim 12, further comprising:
when the content is determined to include the A/V data for multi-angle viewing, determining, from the additional information, whether the A/V data for multi-angle viewing is interleaved.

14. A content transmitting apparatus comprising:
an information generation unit to generate additional information regarding content including audio/video (A/V) data for multi-angle viewing, wherein the additional information is used to record the content; and
a transmitting unit to transmit the content and the additional information to a content recording apparatus that records the content onto a storage medium according to the additional information.

15. The apparatus as claimed in claim 14, wherein:
the additional information comprises content configuration information regarding the A/V data; and
the content configuration information comprises a name, a size, and/or a type of the A/V data, and/or multi-angle information indicating whether the A/V data is related to the multi-angle viewing.

16. The apparatus as claimed in claim 15, wherein:
the A/V data comprises first A/V data for a first angle of the multi-angle viewing and second A/V data for a second angle of the multi-angle viewing; and
the transmitting unit transmits the first A/V data and the second A/V data as interleaved together.

17. The apparatus as claimed in claim 16, wherein the multi-angle information comprises information on each of the interleaved first and second A/V data.

18. The apparatus as claimed in claim 14, wherein the content further comprises navigation data used to control reproduction of the A/V data.

19. An apparatus to record content, the apparatus comprising:
a receiving unit to receive additional information regarding content including audio/video (A/V) data for multi-angle viewing, wherein the additional information is used to record the content; and
a recording unit to record the content onto a storage medium based on the additional information.

20. The apparatus as claimed in claim 19, wherein:
the additional information comprises content configuration information regarding the A/V data; and
the content configuration information comprises a name, a size, and/or a type of the A/V data, and/or multi-angle information indicating whether the A/V data is related to the multi-angle viewing.

21. The apparatus as claimed in claim 19, wherein the receiving unit receives the A/V data comprising first A/V data for a first angle of the multi-angle viewing and second A/V data for a second angle of the multi-angle viewing interleaved together.

22. The apparatus as claimed in claim 19, wherein:
the A/V data comprises first A/V data for a first angle of the multi-angle viewing and second A/V data for a second angle of the multi-angle viewing; and
the recording unit comprises an interleaving unit to interleave, according to the additional information, the first A/V data and the second A/V data together.

23. The apparatus as claimed in claim 22, wherein:
the content comprises navigation data to control reproduction of the A/V data; and
the storage medium is a Blu-ray disc.

24. The apparatus as claimed in claim 22, wherein the interleaving unit divides the first A/V data and the second A/V data into predetermined sized interleaved blocks, and alternately records the interleaved blocks of the first A/V data and the interleaved blocks of the second A/V data onto the storage medium.

25. A computer readable recording medium having recorded thereon a computer program to execute the method of claim 1 and implemented by the content transmitting apparatus.

26. A computer readable recording medium having recorded thereon a computer program to execute the method of claim 6 and implemented by the content recording apparatus.

27. A content recording method of a content recording apparatus, the method comprising:
receiving additional information regarding content including audio/video (A/V) data for multi-angle viewing, wherein the additional information is used to record the content;
determining, from the additional information, whether the content includes the A/V data for multi-angle viewing;
when the content is determined to include the A/V data for multi-angle viewing, determining, from the additional information, whether the A/V data for multi-angle viewing is interleaved;
recording, by the content recording apparatus, the content onto a storage medium based on the additional information when the A/V data for multi-angle viewing is determined to be interleaved; and
interleaving first A/V data for a first angle of the multi-angle viewing with second A/V data for a second angle of the multi-angle viewing and recording, onto the storage medium, the first A/V data and the second A/V data in an interleaved state when the A/V data for multi-angle viewing is determined to not be interleaved.
